(19) United States
(12) Patent Application Publication
(10) Pub. No.: US 2015/0258616 A1
(43) Pub. Date: Sep. 17, 2015

(54) END MILL

(71) Applicant: Frank J Stanbach, Greenville, SC (US)

(72) Inventors: Frank J Stanbach, Greenville, SC (US); Craig Segerlin, (US)

(21) Appl. No.: 14/203,895

(22) Filed: Mar. 11, 2014

(51) Int. Cl. B23C 5/10

(52) U.S. Cl. CPC B23C 5/10; B23C 2210/0492; B23C 2210/40; B23C 2210/54; B23C 2210/64

(57) ABSTRACT

A novel end mill is provided. The end mill may include wide double gashes at the tip having a three-tangent radii, as well as variable flute spacing, eccentric side relief or grind, dubbed radius or land, chip breakers, and/or honed cutting edges. These features may be included in various configurations, depending on the end use and desired capabilities. The tip geometry, including the double gashes with blended, three-tangent radii provides increased performance with respect to ramping or plunging operations. The gashes are used to evacuate extraneous chips during milling, and the wide double gashes increase the efficiency of chip removal.

### BACKGROUND OF THE INVENTION

The present invention relates generally to end mills used in industrial milling applications. More specifically, the present invention is directed to an improved end mill having a unique combination of features to improve the performance and durability thereof.

An end mill is a type of milling cutter, a cutting tool used in industrial milling applications. It is distinguished from the drill bit in its application, geometry, and manufacture. While a drill bit can only cut in the axial direction, a milling bit can generally cut in all directions, though some cannot cut axially. Endmills are used in milling applications such as profile milling, tracer milling, face milling, and plunging.

End mills come in a variety of different configurations depending on the material to be cut and other factors such as the shape of cut to be made and whether the work piece is to be rough cut or cut to precise finish dimensions. Typical end mills have a generally cylindrical form with a shank at one end adapted to be attached to the rotating support of the milling machine and a tip opposite the shank. A series of flutes are cut helically from the tip of the end mill to a midpoint of the end mill where the shank begins. Between the flutes cutting teeth are provided. These teeth have a sharpened cutting edge on a leading side thereof and a heel on a trailing side thereof. Typically, a land exists between the cutting edge and the heel.

This cutting edge of each tooth acts to cut into the work piece when the end mill is traveling laterally and spinning. The tip of the end mill also typically includes sharpened tip cutting edges so that the end mill can also cut the work piece when the end mill is moving axially into the work piece. The specific contours of the tip and cutting edges of the end mill can be configured in many different ways depending on the particular material to be cut and other desired performance characteristics. For instance, the helical angle of the flutes and teeth can vary, the number of flutes and teeth can vary, and other factors such as a degree of radial rake, the degree of relief behind the cutting edge, and particular geometry of the end cutting edges including the various clearance angles, dish angles, axial rake angle, and gash angle can all be particularly selected based on the desired performance for the particular end mill.

Many different types of end mills have been developed, and improvements to end mill technology have been made. For instance, U.S. Pat. No. 5,779,399 is directed to an end mill having a cylindrical shank with a longitudinal axis. Attached to the cylindrical shank is a center flute having a cutting edge extending beyond the longitudinal axis. A non-center flute is also attached to the cylindrical shank. The center flute has a first rake angle and the non-center flute has a second rake angle not equal to the first axial rake.

U.S. Pat. No. 7,399,147 discloses an end mill provided with a plurality of teeth extending helically therealong, and with the teeth notched. The notches interrupt the cutting edge of the teeth at various different positions between a tip of the tooth and a root of the tooth. Various different patterns of notches are disclosed with each notch beneficially followed by a region on a following tooth which is notchless. The notches interrupt an otherwise fiat cutting edge so that a smooth cut into the work piece is provided by portions of the cutting edge between the notches, and by regions on the teeth where no notches are provided.

U.S. Pat. No. 8,277,152 describes an end mill having a gash formed in a top portion of a flute. In a cross-section perpendicular to an intersecting ridgeline between an end cutting edge rake face and a gash bottom face of the gash, the gash bottom face and the end cutting edge rake face, and the gash bottom face and the gash wall face are respectively connected together by first and second connecting faces. The connecting faces have a form, which either is a concave curve or a substantially concave curve formed with straight lines. A radius of curvature of the concave curve or the radius of a circle inscribed within straight lines forming the substantially concave curve about the front connecting face is larger than a radius of curvature of the concave curve or the radius of a circle inscribed within the straight lines forming the substantially concave curve about the second connecting face.

Each of the above-referenced U.S. patents are hereby incorporated herein by reference, in their entire

It would be desirable, however, to provide an end mill with a unique combination of features that allows for milling at a higher speed and feed rate, a greater ramping angle, and is more durable than other end mills commonly available today.

### BRIEF SUMMARY OF THE INVENTION

In accordance with one aspect of the invention, a novel end mill is provided. The end mill of the present invention may include wide double gashes at the tip having a three-tangent radii, as well as variable flute spacing, eccentric side relief or grind, dubbed radius or land, chip breakers, and/or honed cutting edges. These features may be included in various configurations, depending on the end use and desired capabilities. The front end geometry, including the double gashes and blended, three-tangent radii provides increased performance with respect to ramping or plunging operations. The gashes are used to evacuate extraneous chips during milling, and the wide double gashes increase the efficiency of chip removal.

In a preferred embodiment, the end mill includes four flutes, each flute being spaced at a unique angle (“variable flute spacing”), which eliminates or reduces harmonics and vibration (“chatter”) during milling operations. The cutting edge rake face preferably includes a dubbed radius, or a negative rake angle, which enhances the strength and durability of the cutting edge. The cutting faces may also include small, spaced laterally oriented notches or grooves that serve as chip breakers.

### BRIEF DESCRIPTION OF THE DRAWINGS

These and other features, aspects, and advantages of the present invention will become better understood with regard to the following description, appended claims, and accompanying drawings where:

FIG. 1 is a side view of an end mill in accordance with one aspect of the present invention; and

FIG. 2 is an end view showing the tip of an end mill in accordance with one aspect of the present invention.

### DETAILED DESCRIPTION OF THE INVENTION

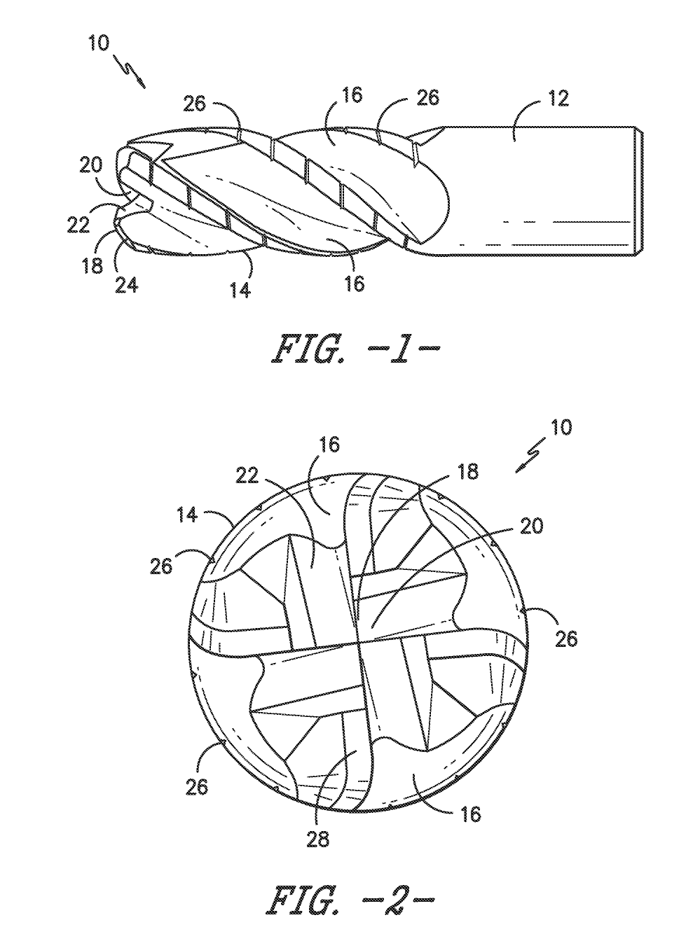

The present invention includes an end mill 10, as shown in FIGS. 1-2. The end mill has a cylindrical shank 12 at a first end, and a cutting edge portion 14 at a second end. A series of flutes 16, preferably four flutes, are positioned along the cutting edge portion 14 in a helix configuration, and each flute 16 includes a generally concave shape as viewed in a cross-sectional direction.

The tip 18 of the end mill 10 preferably includes multiple radii at the end thereof, creating a concave, or “dish” effect 20, and a double gash 22 with a blended tangent radii, which is a series of straight planes formed adjacent one another in a slight angular relation, in order to form each gash 22. In one embodiment, the blended tangent radii includes a three-tangent radii having three successive planes.

The cutting edges of the end mill preferably include a dubbed radius 24 (“land”), or negative rake angle, which adds strength and durability to the cutting edge 14 and rake angle. In one preferred embodiment, a series of transversely oriented notches or grooves 26 are disposed on the outer periphery of the cutting edge 14 along the longitudinal periphery, as shown. These notches 26 are referred to as chip breakers, and are preferably staggered on each cutting edge 14, so that the chip breakers 26 on one cutting edge 14 are not positioned in the same transverse plane as the chip breakers 26 on the adjacent cutting edge 14. Optionally, the cutting edges 14 may be honed using well known honing techniques, in order to prevent edge chipping along the cutting edges.

Variable Flute Spacing

In a preferred embodiment, each flute 16 is disposed and spaced at a unique angle with respect to the other flutes 16. This variable flute spacing serves to reduce or eliminate vibrations or harmonics during the milling operation. A perfectly balanced end mill 10 will resonate at some operating speeds, creating chatter that can damage the tool, the workpiece, and even the milling machine if the vibration is severe enough. Unfortunately, damaging harmonics become more likely as the end mill 10 is pushed to take deeper cuts. One approach to breaking up the harmonics has been to change the timing with which each tooth strikes the part by spacing the flutes 16 unevenly (unequal indexing).

It has been found that varying the helix angle along with the indexing produces better results. Varying both features changes both the timing and angle at which the cutting edge 14 contacts the workpiece. Varying the helix necessarily creates variable unequal indexing along the length of the end mill.

Double Gash

The portion referred to as the gash 22 is positioned adjacent the tip 18 of the end mill 10. Each gash 22 extends radially inwardly from the flutes 16, and serves to evacuate the chips generated from the workpiece during the milling operation. Although a gash 22 may appear to be curved inwardly from the flute 16 near the tip 18 of the end mill 10, in a preferred embodiment, each gash 22 includes multiple (preferably two) straight planes, each one increasingly angled radially inwardly toward the longitudinal axis thereof. Gashes 22 of larger width facilitate the evacuation of the chips in a more efficient manner than narrower gashes.

Eccentric Grind

In one embodiment, the end mill 10 includes an eccentric grind feature 28 on the cutting edges 14 at the tip of the end mill. Eccentric grind 28, also commonly referred to as eccentric relief, means that the cutting edge 14 is formed in such a way as to have convex support behind the cutting edge 14, providing additional strength and durability to the cutting edge 14 of the tip 18. One skilled in the art of end milling will appreciate and understand the concept of the eccentric grind or eccentric relief.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An end mill comprising:
a cylindrical shank portion at a first end and a cutting edge portion at a second end, said cutting edge portion extending from a tip at said second end toward a central portion thereof;
a plurality of helical flutes formed along a periphery of said cutting edge portion;
at least one gash, said gash formed in a top portion of one of said flutes and including a blended radii;
said tip including a concave dish; and
said outer periphery of said cutting edge including a series of spaced, transversely oriented notches for breaking chips off of a workpiece.

2. The end mill set forth in claim 1, wherein said blended radii includes a three-tangent radii.

3. The end mill set forth in claim 1, further including a plurality of said gashes.

4. the end mill set forth in claim 1, wherein said cutting edges are honed edges.

5. The end mill set forth in claim 1, further including an eccentric grind.

6. The end mill set forth in claim 1, wherein said flutes include variable spacing therebetween.

7. The end mill set forth in claim 6, wherein each said flute includes a different helix angle.
